(19) United States
(12) Patent Application Publication
(10) Pub. No.: US 2026/0236664 A1
(43) Pub. Date: Aug. 13, 2026

(54) IMPAIRMENT-SPECIFIC ACCESSIBILITY-AWARE DESIGN SERVICES

(71) Applicant: Capital One Financial Corporation, McLean, VA (US)

(72) Inventors: Lise W. Noble, Chapel Hill, NC (US); Bryce Curtis, Apex, NC (US); Evan Kountouris, Raleigh, NC (US); Keith Smith, Raleigh, NC (US); Matt Mills, Grand Rapids, MI (US); Jonathan Speir, Wauconda, IL (US); Robert del Prado, Los Angeles, CA (US); Courtney Clinton, McLean, VA (US); Maja Dacic, Glenview, IL (US)

(21) Appl. No.: 19/049,551

(22) Filed: Feb. 10, 2025

(51) Int. Cl. G06F 40/106; G06F 40/109

(52) U.S. Cl. CPC G06F 40/106; G06F 40/109

(57) ABSTRACT

Software technology and techniques for facilitating the design and creation of impairment-specific, accessibility-compliant content involve providing a “theme generator” software tool that receives, as input, an initial accessibility theme and an indication of a given impairment. The theme generator tool analyzes design data for the initial accessibility theme based on accessibility compliance standards for the given impairment. Based on the analysis, the theme generator tool generates an impairment-specific accessibility theme that is usable to publish content in a manner that is accessible to content consumers with the given impairment.

### BACKGROUND

A wide range of impairments, such as vision impairments, hearing impairments, learning impairments, motion impairments, cognition impairments, etc., prevent billions of people globally from accessing and interacting with physical and digital content that is socially and economically necessary. The demand for inclusive content that provides accessibility to people with such impairments is rising, as is the need to provide content designers and content producers with tools to consistently generate inclusive, accessible content.

### OVERVIEW

Disclosed herein is new software technology for facilitating the design and creation of impairment-specific, accessibility-compliant content. At a high level, the disclosed software technology comprises a “theme generator” that (i) receives, as input, an initial accessibility theme and an indication of a given impairment, (ii) analyzes design data for the initial accessibility theme based on accessibility compliance standards for the given impairment, and (iii) generates an impairment-specific accessibility theme that is usable to create content accessible to content consumers with the given impairment.

In one aspect, the disclosed software technology may take the form of a method to be carried out by a computing platform that involves (1) receiving, from an end-user device associated with a user, one or more inputs collectively indicating (i) a request to generate impairment-specific accessibility-compliant design data, (ii) initial design data for displaying content and (iii) an indication of a given impairment, (2) based on the request, determining a set of operations to apply to the initial design data in order to generate the impairment-specific accessibility-compliant design data that is usable to produce accessibility-compliant content for the given impairment, (3) applying each operation in the set of operations to the initial design data and thereby generate the impairment-specific accessibility-compliant design data that is usable to produce accessibility-compliant content for the given impairment, and (4) causing the end-user device to display content in accordance with the impairment-specific accessibility-compliant design data for the given impairment.

In an example, the method may further comprise causing the impairment-specific accessibility-compliant design data for the given impairment to be provided to a content producer computing platform for producing accessibility-compliant content for the given impairment.

In an example, the method further comprises causing the end-user device to display a visual representation of the impairment-specific accessibility-compliant design data for the given impairment.

In an example, the method may further comprise (1) receiving, from the end-user device, an indication of user input comprising a modification to the impairment-specific accessibility-compliant design data, (2) based on the modification, updating the impairment-specific accessibility-compliant design data, and (3) causing the end-user device to update the display of the content in accordance with the updated impairment-specific accessibility-compliant design data.

In an example, determining the set of operations that is to be applied to the initial design data may comprise identifying a given impairment-specific accessibility-aware design service corresponding to the given impairment that is configured to dynamically modify one or more design values of the initial design data based on design values for the given impairment, and applying each operation in the set of operations to the initial design data and thereby generating the impairment-specific accessibility-compliant design data may comprise providing the initial design data as input to the given impairment-specific accessibility-aware design service corresponding to the given impairment that is configured to dynamically modify one or more design values of the initial design data based on design values for the given impairment, wherein the generated impairment-specific accessibility-compliant design data comprises the dynamically modified one or more design values of the initial design data.

In one embodiment, the given impairment may comprise dyslexia, the given impairment-specific accessibility-aware design service may comprise a dyslexia-specific accessibility-aware design service, and the set of operations may comprise one or more of (i) modifying a font type design value to an OpenDyslexic font type, (ii) increasing a font weight design value, (iii) increasing a line height design value, (iv) increasing a contrast design value, or (v) changing a text alignment value to left-aligned text.

In another embodiment, the given impairment may comprise motion sensitivity, the given impairment-specific accessibility-aware design service may comprise a motion sensitivity-specific accessibility-aware design service, and the set of operations may comprise one or more of (i) deactivating auto-play of embedded videos, (ii) deactivating jiggling of design element outlines, (iii) deactivating looping animations, or (iv) reducing a size of an embedded design element.

In an example, the set of operations may be a first set of operations, the given impairment may comprise a particular type of colorblindness, the given impairment-specific accessibility-aware design service may comprise a colorblindness-specific accessibility-aware design service, and the first set of operations may comprise (i) modifying a set of initial color values in the initial design data to an updated set of simulated color values that represent the set of initial color values as perceived by an individual with the particular type of colorblindness, thereby generating updated design data, (ii) based on a target accessibility compliance standard, determining a second set of operations to apply to the updated design data to generate colorblindness-specific accessibility-compliant design data for displaying content, and (iii) applying the second set of operations and thereby generating the colorblindness-specific accessibility-compliant design data.

In an example, the initial design data may comprise accessibility-compliant design data previously generated by the computing platform.

In another aspect, disclosed herein is a computing platform that includes a communication interface, at least one processor, at least one non-transitory computer-readable medium, and program instructions stored on the at least one non-transitory computer-readable medium that, when executed by at least one processor, cause the computing platform to carry out the functions disclosed herein, including but not limited to the functions of the foregoing methods.

In yet another aspect, disclosed herein is a non-transitory computer-readable medium provisioned with program instructions that, when executed by at least one processor, cause a computing platform to carry out the functions disclosed herein, including but not limited to the functions of the foregoing methods.

One of ordinary skill in the art will appreciate these as well as numerous other aspects in reading the following disclosure.

### BRIEF DESCRIPTION OF THE DRAWINGS

FIG. 1 depicts an example computing environment in which example embodiments of the disclosed technology may be implemented.

FIG. 2 depicts a structural diagram of an example computing system comprising accessibility-aware design services in accordance with aspects of the disclosed technology.

FIG. 3 depicts a structural diagram of an example computing system comprising impairment-specific accessibility-aware design services in accordance with aspects of the disclosed technology.

FIG. 4 depicts an example user interface view comprising impairment-specific design values that may be modified to display impairment-specific accessible content in accordance with aspects of the disclosed technology.

FIG. 5A depicts an example view of content that may be displayed to a content consumer based on accessibility-compliant design data in accordance with aspects of the disclosed technology.

FIG. 5B depicts an example view of content that may be displayed to a content consumer based on impairment-specific accessibility-compliant design data in accordance with aspects of the disclosed technology.

FIG. 6 depicts a flow diagram of example functionality that may be carried out for generating impairment-specific accessibility-aware design data in accordance with aspects of the disclosed technology.

FIG. 7 depicts a structural diagram of an example back-end computing platform that may be configured to carry out back-end computing platform functionality according to aspects of the disclosed software technology.

FIG. 8 depicts a structural diagram of an example end-user device that may be configured to carry out end-user device functionality according to aspects of the disclosed software technology.

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### DETAILED DESCRIPTION

E-accessibility, also referred to as web accessibility, pertains to the design of websites, mobile applications, and other digital media content in a way that attempts to provide increased accessibility to content consumers with impairments. Such impairments may take various forms. As some non-exhaustive examples, an impairment may take the form of a learning impairment that affects a consumer’s ability to understand or use spoken or written language (e.g., dyslexia, etc.), a visual impairment that affects a consumer’s ability to see (e.g., color-blindness, etc.), a motion impairment that affects a consumer’s sensitivity to visual motion and/or repetitive patterns (e.g., vertigo, etc.), an auditory impairment that affects a consumer’s ability to hear, a motor impairment that affects a consumer’s ability to perform coarse and/or fine motor functions (e.g., manipulating a mouse and/or keyboard, etc.), or an impairment that affect’s a consumer’s ability to focus (e.g., ADHD), among numerous other examples.

As used herein, the term “content consumer” may refer to a user with any impairment that requires content (e.g., digital and/or physical content) to be displayed in a particular way in order for the content to be accessible to the user. In this respect, an “impairment” as used herein may include any condition that presents a barrier to a consumer accessing content and may not be limited to a clinically-defined medical condition or disability (e.g., ADHD, etc.). For instance, an impairment as discussed herein may include, as some non-limiting examples, an impairment that impacts user’s ability to process information (e.g., dyslexia, etc.), a visual impairment (e.g., color-blindness, near-sightedness, far sightedness, light sensitivity, astigmatism, etc.), a motion impairment (e.g., vertigo), or any other auditory, learning, or cognitive condition, among many other possibilities.

The types of impairments noted above and the resulting lack of access to accessible content, particularly web-based content, tends to negatively impact the quality of life for large groups of consumers today. By some estimates, over half of the world’s population (i.e., approximately 5 billion people) use the internet and social media in some form, and over a quarter (i.e., at least 2.2 billion people) suffer from some form of impairment including those described herein. The lack of access to accessible web-based and other digital content for impaired consumers has negative economic effects as well. For example, vision impairments alone present a substantial global financial burden, with the global cost of productivity losses associated with vision impairment estimated to be USD 411 billion annually.

To assist content designers and content producers with the design and creation of web-based content that is accessible to people with impairments like those described herein, various standards have been developed. As used herein, the term “content designer” may refer to any entity that is responsible for determining how published content should appear visually when published. Further, as used herein, the term “content producer” may refer to any entity that is responsible for publishing content for consumption by consumers. A content producer may take various forms, some examples of which include desktop publishers, corporate websites, user interface designers, interface design tool vendors, printing vendors, and financial institutions, among various other possibilities. Furthermore, the term “content” as used herein may refer to any type of content that is produced for visual consumption, including digital content (i.e., content that is produced for electronic consumption, such as on-line content (e.g., via the internet, etc.) and off-line content (e.g., e-books downloaded to an end-user device, etc.), among other possibilities) and physical content (i.e., content that is produced for physical consumption, including printed content such as physical books, magazines, newspapers, among other possibilities).

One prominent example of accessibility standards that have been developed to facilitate provision of accessible content to impaired content consumers is the Web Content Accessibility Guidelines (WCAG) (e.g., WCAG version 2.1), published by the Web Accessibility Initiative (WAI) of the World Wide Web Consortium (W3C), which provides a set of principles, guidelines, and success criteria that can be used to evaluate the accessibility of content. With respect to the success criteria, the WCAG 2.1 standard provides multiple levels of conformance (i.e., levels A, AA, and AAA, with increasingly stringent requirements) that can be achieved by satisfying the success criteria associated with each given level.

The WCAG 2.1 success criteria may take various forms and may correspond to the design of visual elements in a way that has the effect of addressing the accessibility challenges associated with different types of impairments. As one example, the success criteria may designate a minimum contrast level for different types of visual content, (e.g., text, buttons, etc.), where higher conformance levels have a higher minimum contrast level. As another example, the success criteria may designate a minimum target size (e.g., in pixels) for pointer inputs, where higher conformance levels have a higher minimum target size. As yet another example, the success criteria may require that users are able to pause, stop, or hide certain types of moving, blinking, or scrolling content. Numerous other examples of success criteria from WCAG 2.1 and other accessibility design standards are also possible.

Some governmental agencies and businesses worldwide have embraced these accessibility standards and require compliance with a given WCAG 2.1 level for designers and creators of their own web-based content. However, implementation of WCAG 2.1 and similar guidelines in the design and creation of web-based content remains a complex undertaking, and attaining accessibility-compliance is challenging. Moreover, while such standards have been developed for web-based content, no such accessibility standards are available for physical (e.g., printed) content.

Consequently, existing content creation workflows include little or no consideration of accessibility design, and the resulting content created by such workflows often lacks accessibility-compliance in various ways. Further, content creation workflows that do consider accessibility design typically do so in a post-hoc manner, evaluating content that has already been created and published and then attempting to adjust the content as necessary to try to achieve some degree of accessibility-compliance. Further yet, existing content creation workflows typically do not provide a means for content to be designed in a manner that is accessible to consumers with specific impairments, thus limiting accessibility design to general accessibility needs. Further still, there are no existing content creation frameworks to assist content designers and content producers with creating and publishing accessibility-compliant content that is to be consumed in physical form, such as credit cards, promotional material, business correspondence, etc. Furthermore, existing content creation workflows do not provide a mechanism for content producers to obtain impairment-specific accessibility design information that will enable them to publish content in the first instance – either digitally or physically – in a manner that is accessible to users with a given type of impairment.

To address these and other shortcomings, Discover Financial Services (“DFS”) has been developing software technology and tools that provide increased capabilities for content designers and content producers to create accessible content that may be consumed by impaired users. For instance, DFS has developed new software technology comprising accessibility-aware design services that include pre-encoded logic for satisfying accessibility compliance standards, more information about which can be found in U.S. Application No. 18/478,267, filed September 29, 2023, and entitled “Accessibility-Aware Design Services,” and new software technology comprising a theme-builder tool that utilizes the output of the accessibility-aware design services to generate accessibility-compliant design data, more information about which can be found in U.S. Application No. 18/478,443, filed September 29, 2023, and entitled “Theme-Builder for Accessibility-Aware Design Services.” The contents of both of these applications are incorporated by reference herein in their entirety.

Continuing with these advancements, disclosed herein is new software technology for facilitating the design and creation of impairment-specific, accessibility-compliant content. At a high level, the disclosed software technology comprises a “theme generator” that (i) receives, as input, an initial accessibility theme and an indication of a given impairment, (ii) analyzes design data for the initial accessibility theme based on accessibility compliance standards for the given impairment, and (iii) generates an impairment-specific accessibility theme that is usable to create content accessible to content consumers with the given impairment.

As used herein, the terms “accessibility theme” or “theme” may refer to design data that collectively defines a particular visual appearance for content that is to be displayed. Further, as used herein, the terms “accessibility template,” “accessibility theme template,” or “template” may refer one or more files comprising the design data (e.g., one or more CSS files, one or more JSON files, etc.) that are usable (e.g., by a content designer or a content producer) to publish content according to a given accessibility theme. Further yet, as used herein, the term “design token” may refer to a data representation of a design system element that defines a value for a given aspect of design data (e.g., a value for a font type indicating the name of a particular font, a value for a contrast level indicating a particular contrast ratio, a value for a text box size indicating pixel dimensions, etc.) for an accessibility theme.

In one aspect, the disclosed technology provides a mechanism for content designers to create impairment-specific accessibility themes. In another aspect, the disclosed technology provides a mechanism for content producers to access impairment-specific accessibility theme templates that can be used by the content producers to publish their content in a manner that is accessible to content consumers with particular impairments.

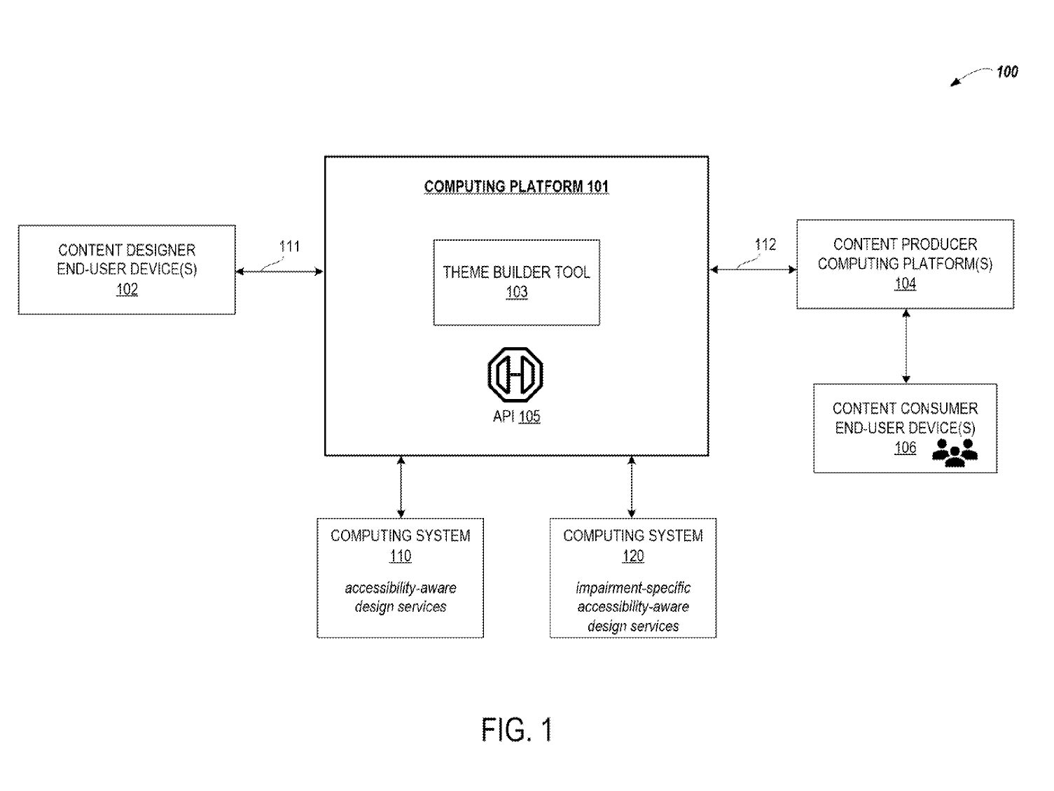

Turning now to the figures, FIG. 1 depicts an example computing environment 100 in which example embodiments of the present disclosure may be implemented. At its core, the computing environment 100 may involve (i) a back-end computing platform 101 comprising a theme builder tool 103, (ii) a content designer end-user device 102, (iii) a content-producer computing platform 104, (iv) a computing system 110 comprising a set of accessibility-aware design services, and (v) a computing system 120 comprising a set of impairment-specific accessibility-aware design services.

In practice, the computing platform 101 may generally comprise some set of physical computing resources (e.g., processors, data storage, communication interfaces, etc.) that are utilized to implement the software technology discussed herein. This set of physical computing resources may take any of various forms. As one possibility, the computing platform 101 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the computing platform 101 may comprise “on-premises” computing resources of the organization that operates the computing platform 101 (e.g., organization-owned servers). As yet another possibility, the computing platform 101 may comprise a combination of cloud computing resources and on-premises computing resources. Further, as yet another possibility, the computing platform 101 may comprise one or more dedicated servers that have been provisioned with software for carrying out one or more of the back-end computing platform functions disclosed herein. The one or more computing resources of the computing platform 101 may take various other forms and be arranged in various other manners as well.

The computing platform 101 may comprise various software components that are configured to facilitate one or more aspects of the functionality disclosed herein.

For instance, as shown in FIG. 1, the computing platform 101 may comprise the theme builder tool 103 that is generally configured to guide users through creation of accessibility themes. For example, as one possibility, a user interacting with the theme builder tool 103 may be a content designer seeking to create an accessibility theme for a particular class of users (e.g., users with a given impairment, users within a given demographic, etc.). In this respect, the theme builder tool 103 may communicate with an end-user device associated with the content designer, such as a content designer end-user device 102, to facilitate creation of an accessibility theme by causing the end-user device 102 to provide one or more user interface views for enabling the content designer to provide user input configuring the accessibility theme. Based on the user input provided at the end-user device 102, the theme builder tool 103 may take various actions, such as generating impairment-specific, accessibility-compliant design data, as will be explained in more detail further below. An end-user device 102 may take any of various forms, examples of which may include a desktop computer, a laptop, a netbook, a tablet, a smartphone, and/or a personal digital assistant (PDA), among other possibilities.

The theme builder tool 103 may take various forms. As one possibility, in line with the discussion above, the theme builder tool 103 may comprise one or more user interface views that enable a user to provide information indicating (i) initial design data for displaying content, which the theme builder tool 103 may embody as a set of design tokens (i.e., a design template) for various aspects of a visual interface design theme, and perhaps also (ii) a given impairment for which impairment-specific accessibility-compliant design data is to be generated based on the initial design data. In general, each design template may collectively define a respective “accessibility theme” that can be used for publishing content at a future time (e.g., used by a content producer to publish content for display to content consumers with a given impairment). Further discussion regarding designing accessible themes and creating design templates for a given theme can be found in U.S. Application No. 18/478,443, incorporated by reference above.

As shown in FIG. 1, the computing platform 101 may also comprise an Application Programming Interface (“API”) 105 that may generally function to allow content producers to access the theme builder tool 103 to obtain design data that can be used for publishing accessibility-compliant content as disclosed herein. For instance, the API 105 may respond to a call from a content producer computing platform 104 (e.g., via the content producer’s API) for design data that the content producer can use to publish accessibility-compliant content (e.g., content that is accessible to content consumers with a given impairment, etc.) for consumption by content consumers via one or more content consumer end-user devices 106.

Although not shown, the computing platform 101 may comprise one or more data stores that generally function to store design data, including design data generated via the theme builder system 103 in line with the discussion above and as disclosed herein. Other examples are also possible.

The computing platform 101 may be configured to communicate with the one or more end-user devices 102 and/or one or more content producer computing platforms 104 over respective communication paths 111 and 112.

Each communication path 111 and/or 112 may generally comprise one or more communication networks and/or communications links, which may take any of various forms. For instance, each respective communication path 111 and/or 112 may comprise any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 111 and/or 112 may be wireless, wired, or some combination thereof, and may carry data according to any of various different communication protocols. Although not shown, the respective communication paths 111 and/or 112 may also include one or more intermediate systems. For example, it is possible that the computing platform 101 may communicate with a given end-user device 102 and/or computing platform 104 via one or more intermediary systems, such as a host server (not shown). Many other configurations are also possible.

Although not shown in FIG. 1, the computing platform 101 may also be configured to receive data from one or more external data sources that may be used to facilitate the functionality disclosed herein. For example, the computing platform 101 may be configured to receive design data from a third-party data source. For instance, in some implementations, the computing platform 101 may enable a user to import a pre-configured accessibility theme stored at a third-party data source, and the computing platform 101 may communicate with the third-party data source to obtain information about the pre-configured accessibility theme. Other examples are also possible.

As shown in FIG. 1, the computing environment 100 may also include a computing system 110 comprising a set of computing subsystems that each hosts a respective accessibility-aware design service corresponding to a given design element. The computing system 110 may generally function to (i) receive, as input, some initial design data and (ii) generate, as output, accessibility-compliant design data, as discussed further below.

Further, as shown in FIG. 1, the computing environment 100 may also include a computing system 120 comprising a set of computing subsystems that each hosts a respective impairment-specific accessibility-aware design service corresponding to a given impairment. The computing system 120 may generally function to (i) receive, as input, initial design data (e.g., design data for a previously-generated accessibility template) and an indication of a given impairment and (ii) generate, as output, impairment-specific accessibility-compliant design data (e.g., an updated, impairment-specific accessibility template) that is usable to publish content that is accessible to content consumers having the given impairment.

In practice, the computing systems 110 and 120 may each be implemented using various different techniques. For example, the computing systems 110 and 120 may each be implemented in part using a service-oriented architecture (SOA) where one or more of their respective subsystems communicate via an enterprise service bus (ESB). As another example, the computing systems 110 and 120 may each be implemented in part using a microservices architecture where one or more of their respective subsystems are deployed in containers and communicate using respective APIs. As yet another example, one or more respective subsystems of the computing systems 110 or 120 may utilize a serverless architecture where the given subsystem is implemented as a set of cloud-based functions that may only be run when another subsystem accesses its API. As suggested above, the computing systems 110 and 120 may each integrate aspects of any of these various architectures, among others, in any combination.

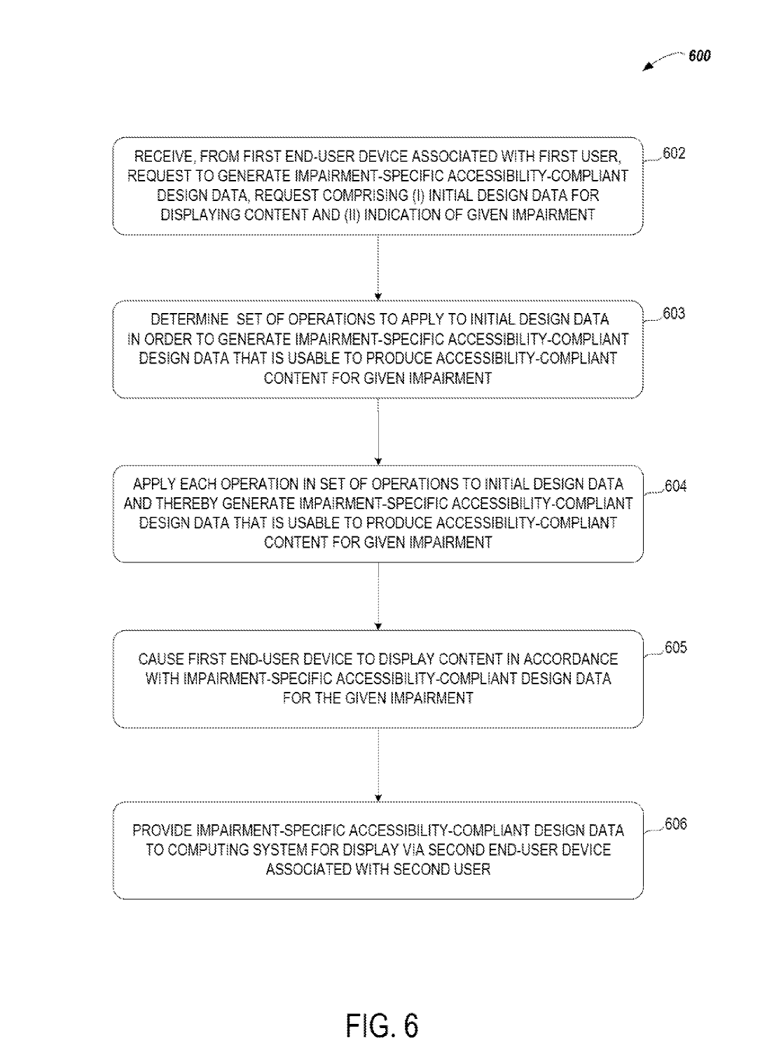

Further, the physical instantiation of the respective subsystems provided by the computing systems 110 and 120 may take various forms. In this regard, it should be noted that the physical hardware (e.g., servers, processors, communication interfaces, etc.) that makes up each respective subsystem provided by computing systems 110 and 120 might not be organized along the same lines as the respective subsystem. For example, a given subsystem may be collectively implemented by two or more physically distinct physical hardware components. Conversely, a single physical hardware component might implement two or more logically separate subsystems (e.g., within separate containers or virtual machines using the same physical hardware). Further, each subsystem may include a network-accessible interface that allows other computing devices, computing systems, and/or computing subsystems—both internal and external—to access it over a network. A given subsystem’s network-accessible interface may take various forms, such as an API, among other possibilities depending on the implementation. Some of the structural components that may be included in the computing systems 110 and 120 are discussed further below in relation to FIG. 7.

Further, although the computing systems 110 and 120 shown in FIG. 1 are depicted as separate from the computing platform 101 comprising the theme builder tool 103, other arrangements are also possible. For example, as one possibility, the computing platform 101 may additionally comprise one or both of the computing systems 110 or 120. As another possibility, the theme builder tool 103 may run on an end-user device (e.g., the content designer end-user device 102) that is separate from, but in communication with, one or both of the computing systems 110 or 120. The end-user device 102 may receive user input from the designer and transmit corresponding design data to one or both of the computing systems 110 or 120, which may in turn transmit accessibility-compliant design data and/or impairment-specific accessibility-compliant design data to the end-user device 102. Other possibilities also exist.

The computing systems 110 and 120 and their respective subsystems and corresponding services will be described in more detail further below.

It should be understood that the computing environment 100 is one example of a computing environment in which embodiments described herein may be implemented. Numerous other arrangements are possible and contemplated herein. For instance, other computing environments in line with other embodiments of the disclosed technology may include additional components not pictured and/or more or fewer of the pictured components.

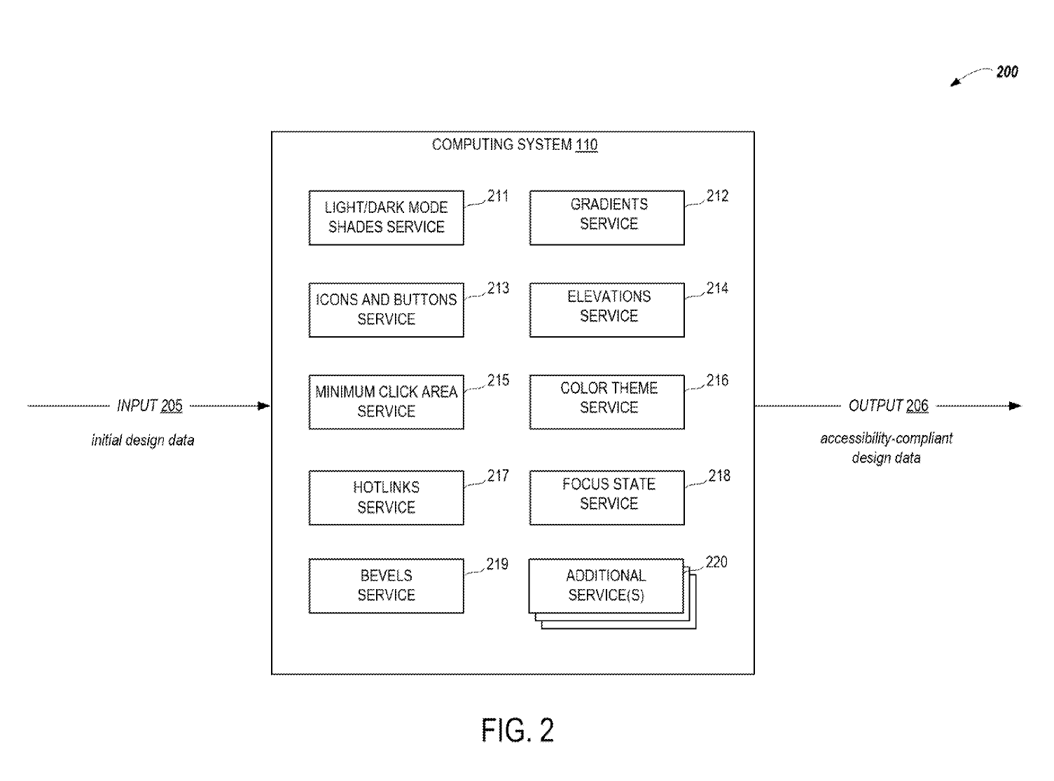

FIG. 2 depicts a structural diagram of one example of the computing system 110 in accordance with one embodiment of the disclosed technology. As mentioned above, the computing system 110 may comprise a set of subsystems each hosting a respective accessibility-aware design service that corresponds to a given design element of a visual interface design. The computing system 110 may generally function to (i) receive an input 205 comprising some initial design data and (ii) generate an output 206 comprising accessibility-compliant design data, and each subsystem of the computing system 110 may be configured to (i) receive an input comprising some initial design data and (ii) generate an output comprising accessibility-compliant design data.

In some implementations, the example accessibility-aware design services shown in FIG. 2 may form part of the theme builder tool 103 that is provided by the computing platform 101. As discussed above, the theme builder tool 103 may guide content designers through the creation of an accessibility-compliant accessibility theme using one or more of the accessibility-aware design services shown in FIG. 2. The theme builder tool 103 may use information provided by the accessibility-aware design services, in conjunction with various content designer user inputs, to define the design components of a given accessibility theme, facilitate edits by a content designer to those components (e.g., within accessibility compliance standard(s)), and dynamically display a visual preview of the components and/or content for review by the content designer, as described in more detail in U.S. Application No. 18/478,443, incorporated by reference above.

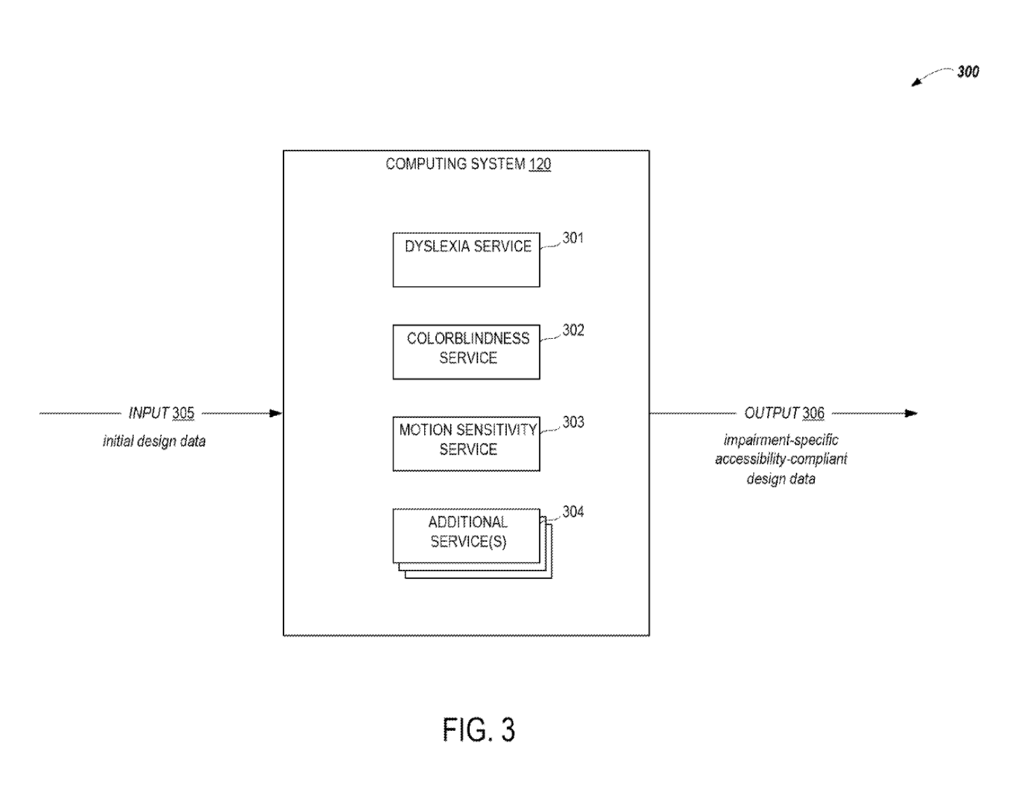

For each design component that is defined via the subsystems 211-220, the computing system 110 may generate a set of accessibility-compliant design data that may collectively form the accessibility-compliant design data comprising the output 206. In this respect, the output 206 may take various forms, such as a cascading style sheet (CSS) file or a JavaScript object notation (JSON) file, among other examples, which may be used to generate impairment-specific accessibility-compliant design data as will be explained further below with respect to FIG. 3.

As noted above, the accessibility-aware design services discussed herein that are hosted by the various subsystems of the computing system 110 may take various forms, several examples of which are shown in FIG. 2. Beginning with subsystem 211, a light and dark mode shades service (“shades service”) may be provided. At a high level, the light and dark mode shades service is a service that, given an indication of an initial input color from a content designer, applies a set of logical instructions for creating ten light mode shades for the initial color, ten dark mode shades for the initial color, and a corresponding on-color for each shade that meets a designated accessibility standard. For example, the WCAG 2.1 accessibility standard requires an on-color contrast ratio of 4.5:1 to meet conformance level AA and a contrast ratio of 7:1 to meet conformance level AAA. In this regard, a desired conformance level may be indicated in the input data that is provided by the content designer, and the light and dark mode shades service may determine the required contrast ratio to use based on the desired conformance level.

Once the light and dark mode shades have been determined, each respective shade may then be checked against default light and dark text to determine which has a higher contrast with respect to the respective shade. If the higher-contrast text results in a contrast ratio that is greater than the minimum value indicated by the desired conformance level (e.g., WCAG 2.1, 4.5:1), then the shades service may designate that text as the on-color for the respective shade whenever the respective shade is used during content design/creation. Alternatively, if the higher-contrast text for a given shade does not have a contrast-ratio greater than the minimum value required, the shades service may incrementally lighten (for dark text) or darken (for light text) the respective shade to increase the contrast until the minimum contrast ratio is met.

Lastly, if any of the ten light mode shades or the ten dark mode shades were lightened or darkened to increase contrast, the shades service may smooth out the transitions through the ten shades so as to minimize any stark jumps between adjacent shades. For example, the shades service may place a set of lightened or darkened shades along a gradient between the lightest and darkest shades and update the intervening shades in each direction at equal percentage intervals.

Turning to subsystem 212, a gradients service may be provided. At a high level, the gradients service is a service that, given an indication of a set of colors that will be used for a given accessibility theme (e.g., primary, secondary, tertiary colors), applies a set of logical instructions for the selection of gradient colors and a complementing set of text and icons colors, such that all text and icons placed over the gradient, with all its varying shades, meet the minimum contrast ratio.

Turning to subsystem 213, an icons and buttons service may be provided. At a high level, the icons and buttons service is a service that, given an indication of the set of colors that will be used for a given accessibility theme (e.g., primary, secondary, tertiary colors) and the light mode and dark mode background colors, applies a set of logical instructions for selecting icon and button colors based on colors that will meet the minimum contrast ratio against their background.

Turning to subsystem 214, an elevations service may be provided. At a high level, the elevations service is a service that applies logic for creating respective sets of ten elevations for light mode and dark mode colors based on a content designer’s input indicating a desired box shadow styling.

Turning to subsystem 215, a minimum click area control service may be provided. At a high level, the minimum click area control service is a service that applies logic for defining a design system’s minimum click area (e.g., in pixels) for pointer inputs. For example, a WCAG 2.1 compliance level AA requires a minimum click area of 24 pixels for desktop applications and a minimum click area of 44 pixels for tablet and mobile applications. Thus, the minimum click area control service may include logic for creating buttons and chips that appear visually smaller than the minimum required click area, but nonetheless meet the click area requirements. For instance, in the context of a mobile application with a minimum click area of 44 pixels, a small button that has a visual appearance that is only 28 pixels tall may be contained within a clickable area that is 44 pixels tall, with 8 pixels of padding on the top and bottom of the button. This feature advantageously allows a content designer to create visually smaller elements that are less overwhelming in an interface while still meeting accessibility guidelines.

Turning to subsystem 216, a color theme service may be provided. At a high level, the color theme service is a service that, given a previously-created accessibility template and a new set of desired colors, applies a set of logical instructions for generating a new accessibility template that changes only the coloring of the elements in the resulting instrument based on the new set of desired colors. For example, a content designer may provide user input specifying a color theme including primary, secondary, and tertiary colors, light and dark mode backgrounds, gradients, buttons, icons, and text gradient colors, as generally discussed above, based on which new light and dark mode shades may be generated according to the new set of desired colors. Advantageously, the color theme service may be used to develop a dark mode for an existing template that did not previously have a dark mode, or to otherwise darken an existing template to reduce eye strain while maintaining required contrast levels. In this regard, the color theme service may also adjust the brightness of images by adding on a desaturation layer (e.g., a black layer with an opacity of 5%) over the image.

Turning to subsystem 217, a hotlinks service may be provided. At a high level, the hotlinks service is a service that applies logic for generating selectable hotlinks (or hyperlinks) that are discernible to meet a designated accessibility compliance guideline. For example, WCAG 2.1 conformance level AA requires that hotlinks have a contrast ratio of 3.1:1 against a background as well as a contrast ratio of 3.1:1 against surrounding text if the link is not underlined. The hotlinks service includes logic for handling various other complexities related to hotlink state and appearance.

Turning to subsystem 218, a focus state service may be provided. At a high level, the focus state service is a service that applies logic for creating a focus state for clickable interface items (e.g., buttons). For example, the focus state may include a visual indicator with a contrast of 3.1:1 against the background, as required by WCAG 2.1 conformance level AA.

Turning to subsystem 219, a bevels service may be provided. At a high level, the bevels service is a service that applies logic for creating varying bevels, reverse bevels, and inset shadow effects based on user input provided by a content designer. Bevels are similar to elevations and add the visual effect of 3D depth to a graphic or text object by making a light shadow on the top and left side of a shape and a dark shadow on the right and bottom side of a shape. An inverse bevel applies a dark shadow to the top and right side of a shape making it look three dimensionally recessed.

The additional subsystems 220 of the computing system 110 may run any number of additional design services similar to those discussed above, corresponding to any number of design elements and/or accessibility compliance criteria. Further information regarding accessibility-aware design services including those noted above can be found in U.S. Patent Application No. 18/478,267 previously incorporated above.

After the input 205 has been run through one or more of the subsystems 211-220 in line with the discussion above, the resulting accessibility-aware design data may comprise the output 206, which may be stored by the computing system 110 and/or the computing platform 101. Further, the output 206 may be provided to the content designer end-user device 102 (e.g., in the form of an accessibility theme template comprising a CSS or JSON file, among other possibilities), whereupon a visual representation of the output 206 may be displayed for viewing (and/or modification) by the content designer. The output 206 may be utilized for various purposes, including as one example, serving as input that is provided to the computing system 120 for generating impairment-specific accessibility-compliant design data, as will be explained in more detail below.

Turning now to FIG. 3, a structural diagram 300 of one example of the computing system 120 in accordance with one embodiment of the disclosed technology is shown. As mentioned above, the computing system 120 may comprise a set of subsystems each hosting a respective impairment-specific accessibility-aware design service that corresponds to a given impairment. The computing system 120 may generally function to (i) receive an input 305 comprising initial design data and an indication of a given impairment and (ii) generate an output 306 comprising updated, impairment-specific design data that is usable to publish content that is accessible to content consumers having the given impairment.

The input 305 may take various forms. As one possibility, the input 305 may comprise initial accessibility-compliant design data based on which the computing system 120 is to generate impairment-specific accessibility-compliant design data. For instance, as one example, the input 305 may comprise accessibility-compliant design data that was generated by the computing system 110. For example, a content designer may access the theme builder tool 103 via an end-user device 102 and thereby provide user input configuring a new accessibility theme in line with the discussion above with respect to FIG. 2, in which case the accessibility-compliant design data comprising the output 206 that was generated by the computing system 110 may serve as the input 305.

However, while the accessibility theme generated by the theme builder tool 103 may be generally compliant with accessibility standards as described above, the content designer may wish to generate an impairment-specific version of the accessibility theme that further improves accessibility for individuals with a specific impairment. For instance, based on specific challenges related to presenting content to individuals with dyslexia, values for certain design elements may be adjusted beyond the values required to meet the more general standards for a given accessibility guideline (e.g., WCAG 2.1 conformance level AA). The resulting design data for the impairment-specific accessibility theme that is generated by the computing system 120 satisfies both the general standards for the given accessibility guideline and also provides updates that are tailored to the specific impairment.

In some embodiments, after the output 206 has been generated as discussed above, the content designer may be presented with an option to generate an impairment-specific version of the accessibility theme (e.g., the output 206), selection of which may cause the output 206 to be provided to the computing system 120. For instance, the content designer may provide user input selecting the option to generate an impairment-specific version of the accessibility theme and also indicating a given impairment (e.g., dyslexia) for which the impairment-specific version of the accessibility theme is to be generated. Based on the user input, the end-user device 102 may transmit to the computing system 120 (either directly or via the computing platform 101, depending on the implementation as discussed above) a request to generate an impairment-specific version of the accessibility theme. The request may comprise (i) the accessibility-aware design data that was generated as the output 206 and (ii) an indication of the given impairment, which may collectively form the input 305 shown in FIG. 3. Based on receiving the input 305, the computing system 120 may perform one or more operations determined by a given impairment-specific accessibility design service and thereby generate impairment-specific accessibility-aware design data that can be used to publish content that is accessible to content consumers having the given impairment. The input 305 may take other forms as well.

As shown in FIG. 3, the computing system 120 may comprise one or more subsystems that each hosts a respective impairment-specific accessibility-aware design service that corresponds to a given impairment. In this respect, the indication of the given impairment included in the input 305 may indicate a given subsystem hosted by the computing system 120. For instance, when providing the user input selecting the option to generate an impairment-specific version of the accessibility theme and also indicating the given impairment for which the impairment-specific version of the accessibility theme is to be generated, the content designer may be presented with respective selectable impairment options (e.g., dyslexia, colorblindness, motion sensitivity, etc.) corresponding to the impairment-specific accessibility-aware design services run by the computing system 120, based on which the content designer may select the respective option indicating the given impairment. In turn, the computing system 120 may provide the initial design data included in the input 305 to a particular subsystem that hosts the impairment-specific accessibility-aware design service corresponding to the given impairment.

In some implementations, the example impairment-specific accessibility-aware design services shown in FIG. 3 may form part of the theme builder tool 103 that is provided by the computing platform 101. In this respect, the theme builder tool 103 may use information provided by the impairment-specific accessibility-aware design services, in conjunction with various content designer user inputs, to modify the design components of a given accessibility theme, facilitate edits by a content designer to those components, and dynamically update a visual display of the design components and/or content for review by the content designer, as will be described in more detail below.

As noted above, the impairment-specific accessibility-aware design services that are hosted by the various subsystems of by the computing system 120 may take various forms, some examples of which are shown in FIG. 3. Beginning with a subsystem 301, a dyslexia service may be provided. At a high level, the dyslexia service is a service that applies a set of logical instructions to modify one or more values (e.g., design tokens) of the initial design data included in the input 305 based on dyslexia-specific design values and thereby generates new, dyslexia-specific accessibility design data that is usable to publish content for content consumers having dyslexia. In this respect, the set of logical instructions that are applied to modify the one or more values in the initial design data may involve comparing each design token of a respective design element to corresponding dyslexia-specific design values and then dynamically modifying any non-compliant design token in accordance with the dyslexia-specific design values.

Modifying a design token in accordance with dyslexia-specific design values may take various forms. As one example, modifying a design token for a given theme in accordance with dyslexia-specific design values may comprise changing an existing font type to a font type that is easier for dyslexic individuals to read, such as OpenDyslexic. As another example, modifying a design token in accordance with dyslexia-specific design values may comprise increasing an existing font weight to make the displayed font heavier (e.g., bolder). For instance, the font weight may be increased to a predetermined minimum value, perhaps in combination with one or more other design values (e.g., a minimum line weight for a given contrast between a text color and a background color). As yet another example, modifying a design token in accordance with dyslexia-specific design values may comprise increasing a line height (e.g., to a predetermined minimum line height). Further, as another example, modifying a design token in accordance with dyslexia-specific design values may comprise increasing contrast between design elements, such as a contrast between a background color and a color for a hotlink, a button, an icon, or some other design element. Further yet, as another example, modifying a design token in accordance with dyslexia-specific design values may comprise changing a text alignment to left-aligned text. Other examples are also possible.

Turning to subsystem 302, a colorblindness service may be provided. At a high level, the colorblindness service is a service that applies a set of logical instructions to modify one or more values (e.g., design tokens) of the initial design data included in the input 305 based on colorblindness-specific design values and thereby generates new, colorblindness-specific accessibility design data that is usable to publish content for content consumers having colorblindness.

In general, most humans visually experience a combination of three primary colors – also known as trichromacy – which involves three types of ocular cone cells in the human eye that function to perceive colors of objects. Individuals who are unable to experience trichromacy typically have a trichromacy anomaly that adversely impacts their ability to perceive certain colors, shades, or hues, thus making them “blind” (e.g., partially blind, fully blind) to those colors. These anomalies may take various different forms and may manifest with various degrees of severeness. Each such anomaly may require different adjustments to specific design values in order for content to be accessible to content consumers having that type of anomaly. For instance, a first type of anomaly known as deuteranomaly causes reduced sensitivity to green light, which creates difficulty perceiving green colors and/or distinguishing between red, green, brown, and orange colors and between blue and purple colors, along with other color combinations. A second type of anomaly known as protanomaly causes reduced sensitivity to red light, which creates difficulty perceiving red colors and/or distinguishing between red, green, brown, and orange colors and between blue and purple colors, along with other color combinations. A third type of anomaly known as tritanomaly causes reduced sensitivity to blue light, which creates difficulty perceiving blue colors and/or distinguishing between blue and yellow colors, between violet and red colors, and between blue and green colors. A fourth type of anomaly known as monochromacy causes reduced sensitivity to colors generally, which results in perception of colors as varying shades of grey ranging from black to white. Other types of colorblindness are also possible.

The colorblindness service may generate the new, colorblindness-specific accessibility design data based on a given type of colorblindness, which may be indicated by the content designer when indicating the given impairment in line with the discussion above. For instance, in one implementation, at the time of providing user input indicating a given impairment, a content designer may be prompted to provide additional information regarding the given impairment. For instance, after selecting an impairment option corresponding to colorblindness, the content designer may be presented with one or more user interface views and/or prompts that enable the content designer to provide user input indicating additional information, such as a given type of colorblindness anomaly and/or one or more colors, shades, or hues for which perception is affected by a given type of colorblindness anomaly, in line with the discussion above.

The set of logical instructions that are applied to modify the one or more values of the initial design data included in the input 305 to generate a colorblindness-specific version of an accessibility theme may take various forms. In one implementation, the colorblindness service may begin by converting design tokens of the initial design data provided in the input 305 based on the given type of colorblindness. For instance, the colorblindness service may convert design tokens indicating an initial color value to updated design tokens that indicate a color value that simulates the perception of an individual with the given type of colorblindness. As one possibility, the colorblindness service may receive an indication of protanomaly (red-blind) colorblindness, and thus may remove the red component from any color values indicated in design tokens for the initial design data. The resulting, updated design tokens that initially had red, orange and green color values will be updated with more brown values, and initially purple color values will be updated to more blue color values, to simulate the perception of an individual with protanomaly colorblindness.

As a result of updating the design tokens in this way, various aspects of the updated design data that were initially compliant with a given accessibility standard (e.g., WCAG 2.1 AA) may no longer satisfy the minimum requirements for compliance. For example, due to the changes in color values, various aspects of the updated design data may not satisfy the WCAG 2.1 AA minimum on-color contrast ratio of 4.5:1.

Accordingly, the updated design tokens may be evaluated against a target set of accessibility guidelines to ensure that the design elements of the simulated theme, including the simulated color values, are adjusted to meet minimum accessibility standards. As one possibility, the colorblindness service may provide the updated design data for the simulated theme as input to the computing system 110. One or more of the accessibility-aware design services hosted thereon may receive the updated design data as input, determine a set of operations to apply to the updated design data to generate accessibility-compliant design data, and then apply the operations to thereby generate new, accessibility-compliant design data for the colorblindness theme that incorporates the color limitations of the particular type of colorblindness. For instance, the light and dark mode shades service provided by the subsystem 211 may generate sets of light and dark mode shades for the simulated colors as well as corresponding on-colors for each shade that meet the designated accessibility standard. Other aspects of updated design data may be evaluated in a similar way, with the accessibility-aware design services of computing system 110 generating new design data where necessary to meet the designated accessibility standard. The new impairment-specific accessibility-compliant design data that is generated in this way (e.g., a new theme comprising new design tokens) can then be utilized as a colorblind-specific version of the initial accessibility theme that provides increased accessibility to individuals with the particular type of colorblindness.

Additionally or alternatively, in some implementations, the colorblindness service may evaluate the design tokens in the initial design data provided in the input 305 to identify certain color combinations that are known to impact color perception by content consumers having a particular type of colorblindness, and which should be avoided. For example, certain colors that look different to individuals with trichromatic vision may appear approximately the same to individuals with certain types of colorblindness. Such combinations may take various forms. For instance, such combinations may include a green-red combination, a green-blue combination, a green-brown combination, a green-black combination, a green-grey combination, a blue-grey combination, a light green-yellow combination, or a blue-purple combination, among other possibilities. In these cases, it may be difficult or impossible to generate new impairment-specific design data that distinguishes these colors using the approach discussed above. In such instances where the initial design data provided in the input 305 includes a combination of colors that, in conjunction with the indicated type of colorblindness, should be avoided, the computing system 120 may cause a notification to be provided to an end-user device associated with a content designer indicating that the combination of colors should be avoided.

Turning to a subsystem 303, a motion sensitivity service may be provided. At a high level, the motion sensitivity service is a service that applies a set of logical instructions to modify one or more values (e.g., design tokens) of the initial design data included in the input 305 based on motion sensitivity-specific design values and thereby generates new, motion sensitivity-specific accessibility design data that is usable to publish content for content consumers having a motion sensitivity impairment.

In this respect, the set of logical instructions that are applied to modify the one or more values in the initial design data may involve comparing design tokens of respective design elements in the initial design data to corresponding motion sensitivity-specific design values and then dynamically modifying any non-compliant design token in accordance with the motion sensitivity-specific design values.

The design elements for which the motion sensitivity service may evaluate design tokens may take various forms, including jiggling design element outlines to indicate a required task or otherwise draw attention, auto-play of embedded videos, looped animation of embedded elements (e.g., GIFs, banners, etc.), or any other continuously-looping and/or moving elements (e.g., a moving mascot, etc.), among other possibilities.

Modifying a design token in accordance with motion sensitivity-specific design values may take various forms. As one example, modifying a design token for a given theme in accordance with motion sensitivity-specific design values may comprise turning off jiggling of design element outlines such that they remain static. As another example, modifying a design token in accordance with motion sensitivity-specific design values may comprise turning off auto-play for embedded videos. As yet another example, modifying a design token in accordance with motion sensitivity-specific design values may comprise turning off looped animation for embedded GIFs. Still further, as another example, modifying a design token in accordance with motion sensitivity-specific design values may comprise reducing an extent and/or distance of movement of a dynamic design element. Further still, as another example, modifying a design token in accordance with motion sensitivity-specific design values may comprise reducing a display size of an embedded design element (e.g., a video, an animated banner, etc.). Other examples are also possible.

In some situations, similar to the colorblindness service provided by the subsystem 302, the motion sensitivity service provided by the subsystem 303 may evaluate the initial design data and determine that certain design element values that should be avoided and/or should be modified by the content designer, and the computing system 120 may cause a notification to be provided to the end-user device 102 indicating that the content designer should make certain adjustments. For instance, some elements of motion within a design theme might not be easily turned off or suppressed by updating a design token, as in the examples above. For example, the motion sensitivity service may identify animations that move in a different direction than a scrolling direction of user input, or in a way that is not directly linked to a scrolling speed and/or direction of the user input, and may identify these a design elements to be avoided.

The additional subsystems 304 of the computing system 120 may run any number of impairment-specific accessibility-aware design services similar to those discuss above, corresponding to any number of impairments. In line with the discussion above, each such service may apply a set of logical instructions to modify one or more values (e.g., design tokens) of the initial design data included in the input 305 in order based on impairment-specific design values for some other given impairment and thereby generate new, impairment-specific accessibility-compliant design data that is usable to publish content for content consumers having the other given impairment.

The computing system 120 may take other forms as well.

In line with the discussion above, the computing system 120 may modify the initial design data included in the input 305 and thereby generate the impairment-specific accessibility-compliant design data, which may form the output 306.

After generating the output 306, the computing system 120 may take various other actions. For instance, as one possibility, the computing system 120 may cause a content designer end-user device, such as the end-user device 102, to display a visual representation of the output 306 in order to enable the content designer to review and/or make further modification to one or more design tokens for the impairment-specific accessibility-compliant design data. For instance, the impairment-specific accessibility-compliant design data in the output 306 may be displayed and modified via the theme builder tool 103. In this respect, theme builder tool 103 may evaluate (e.g., via the computing system 120 and/or the computing system 110) any proposed modification to determine whether it meets the impairment-specific design values and the minimum accessibility guidelines as described above. If the proposed modification is compliant, the theme builder 103 may update the impairment-specific accessibility-compliant design data in accordance with the proposed modification. On the other hand, if the proposed modification is non-compliant, the theme builder 103 may cause the end-user device 102 to display an indication of the non-compliance, perhaps along with instructions and/or information for making the proposed modification compliant. In some implementations, the visual representation of the impairment-specific accessibility-compliant design data may be presented in a manner that enables modification of design tokens only within certain ranges that are compliant with impairment-specific design values or general accessibility-compliant values (e.g., of a given WCAG compliance level), thus restricting modification of the design tokens to compliant-only values. Other examples are also possible.

In some implementations, the visual representation of the output 306 may additionally include, or be accompanied by, a display of content in accordance with the impairment-specific design values. Further, the display of the content may be dynamically updated based on any modifications made to design tokens for the impairment-specific design values.

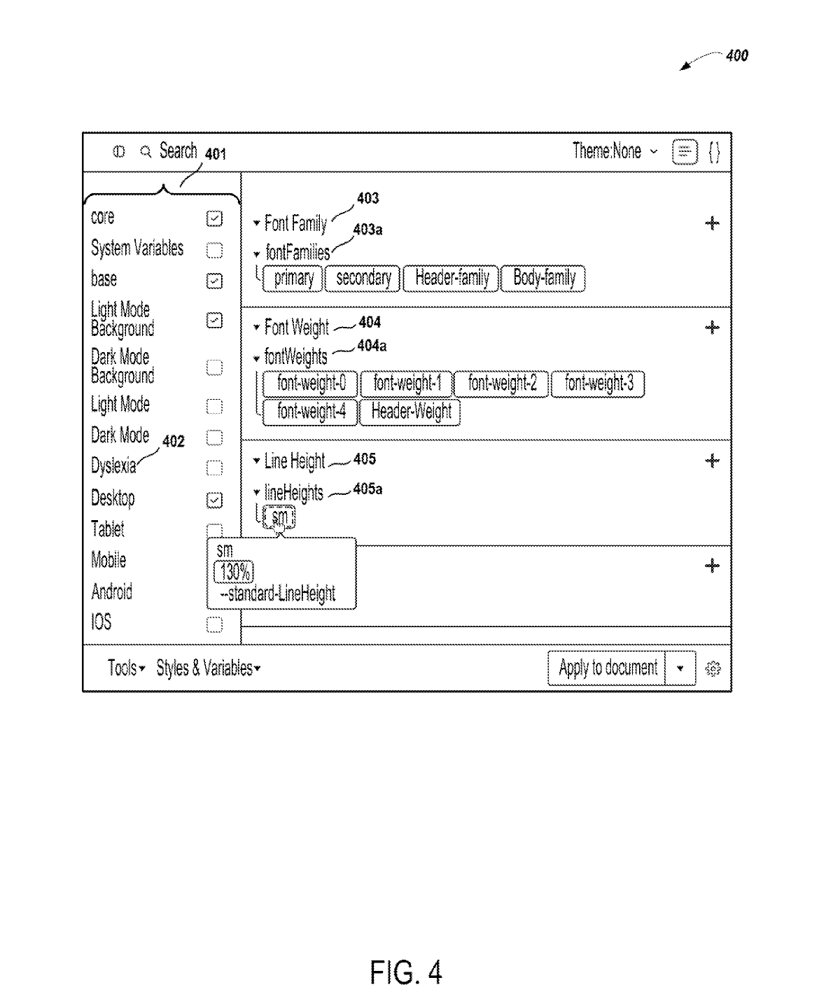

The visual representation of the output 306 may take various forms. For instance, as one possibility, the visual representation of the output 306 may comprise an editable representation of the one or more design tokens for the impairment-specific accessibility-compliant design data that may be presented by the end-user device 102 for review and/or modification by the content designer. FIG. 4 depicts one example of a visual representation 400 that may be presented to the content designer. The visual representation 400 may include a panel 401 including various categories of design tokens that may be modified. The various categories may include one or more impairments, one or more types of applications for accessing content, and one or more types of computing device operating systems, among other possibilities.

As shown in FIG. 4, the panel 401 includes a category 402 for dyslexia, which may be the given impairment that was indicated in the request by the content designer to generate the impairment-specific accessibility-compliant design data. The dyslexia category 402 may comprise one or more design elements each having a set of one or more dyslexia-related respective design tokens (e.g., design values) that may be modified by the content designer. For instance, as one possibility, a font family design element 403 may indicate a set of respective design tokens 403a from which the content designer may select a given font family for displaying content. As another possibility, a font weight design element 404 may indicate a set of respective design tokens 404a from which the content designer may select a given font weight for displaying content. As yet another possibility, a line height design element 405 may indicate a set of respective design tokens 405a from which the content designer may select a given line height for displaying content.

The design tokens depicted in the visual representation 400 may comprise design tokens that have been configured in accordance with the impairment-specific design values as determined by the computing system 120. In line with the discussion above, the content designer may make further modifications to the design tokens based on personal preferences, in response to which the content designer may be presented with content that is dynamically updated based on any such modifications.

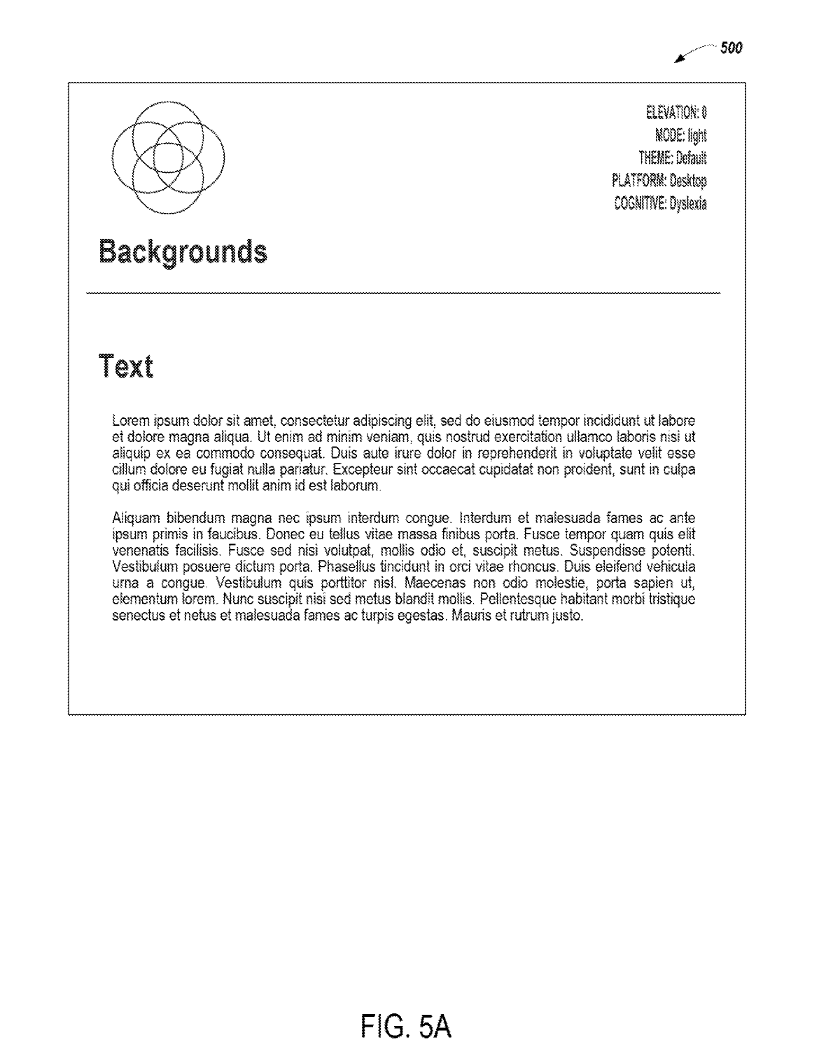

For instance, FIG. 5A depicts an example view of content 500 that may be displayed in accordance with initial design data (which may be accessibility-compliant but not impairment-specific accessibility-compliant). After the impairment-specific accessibility-compliant design data is generated by the computing system 120 in line with the discussion above, the end-user device 102 may display an updated version of the content 500. FIG. 5B depicts an example view of content 510 comprising an updated version of the content 500. The content 510 may be displayed in accordance with the dyslexia-specific accessibility-compliant design data that was generated by the computing system 120. As shown in FIG. 5B, the content 510 has an updated font type, updated font weight, and updated line spacing as compared to the content 500. For instance, the font type may be updated from a standard font type to a dyslexia-specific font type (e.g., OpenDyslexic), the font weight may be increased, the spacing between characters may be increased, the spacing between paragraphs may be increased, and the spacing between items displayed may be increased.

As another possibility, the computing system 120 may provide the output 306 (e.g., in the form of a template file) to a content producer computing platform, such as the content producer computing platform 104. Thereafter, the content producer computing platform 104 may receive a request from one or more content consumer end-user devices, such as the content consumer end-user device(s) 106 to view content according to an impairment-specific theme. For instance, a content consumer may wish to view given content provided by a content producer associated with the content producer computing platform 104 and may use an end-user device 106 to request the given content, which may involve, for example, accessing a web application run by the computing platform 104. In practice, the content consumer may be provided with an option to view an impairment-specific version of the given content. For instance, as one possibility, the content consumer may access user settings to indicate a preference to view content provided by the content producer in a manner that is accessible to consumers with a given impairment. As another possibility, the content consumer may be provided with a prompt or other design interface element that enables the content consumer to request or otherwise indicate a preference to view the content provided by the content producer in a manner that is accessible to consumers with a given impairment. In any event, based on the request and/or indication, the content producer computing platform 104 may display the given content in accordance with impairment-specific accessibility-compliant design data for the given impairment generated by the computing system 120. For instance, in line with the discussion above, the computing platform 104 may interact with the computing platform 101 to obtain impairment-specific accessibility-compliant design data for the given impairment (e.g., a CSS file, etc.) that is usable to publish the given content in accordance with design values for the given impairment.

In an implementation where the computing system 120 is part of the computing platform 101, the computing platform 101 may interact with the end-user device(s) 102 and/or the computing platform(s) 104 to provide the output 306 as discussed above. However, in an implementation where the computing system 120 is separate from the computing platform 101, the computing system 120 may interact directly with the end-user device(s) 102 and/or the computing platform(s) 104 to provide the output 306 as discussed above.

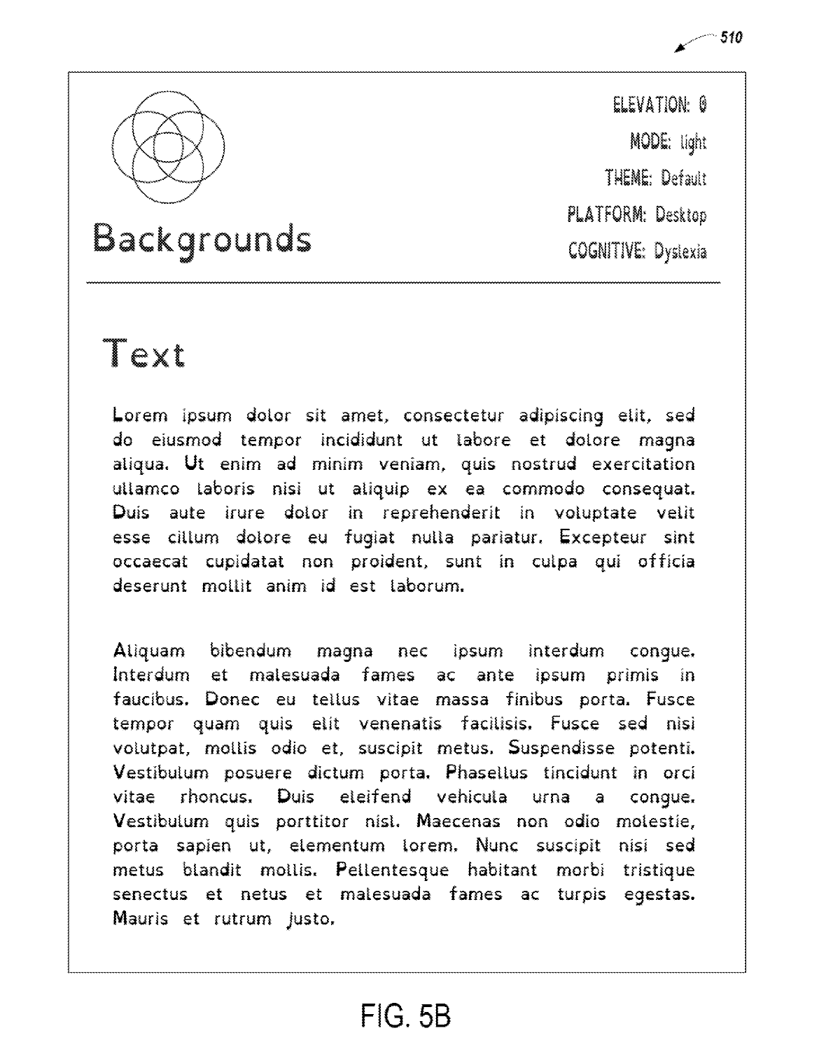

Turning now to FIG. 6, a flow chart of example functionality 600 for facilitating generation of impairment-specific accessibility-compliant design data in accordance with one embodiment of the disclosed technology is shown. For purposes of illustration, in the discussion below, the example functionality 600 will be described in the context of a computing environment that includes a content designer end-user device 102, a back-end computing platform 101 including a computing system 120 that hosts a set of subsystems corresponding to respective impairment-specific accessibility-aware design services, a content producer computing platform 104, and a content consumer end-user device 106, in line with the discussion above.

In practice, the example functionality 600 may begin with a content designer using the content designer end-user device 102 to access the computing platform 101 including the computing system 120 and navigating to a user interface view whereby the content designer may provide user input requesting impairment-specific accessibility-compliant design data that is usable to produce accessibility-compliant content for content consumers having a particular impairment. In line with the discussion above, the user input may indicate (i) initial design data (e.g., an accessibility-compliant theme that has been generated using the theme builder tool 103) and (ii) a given impairment based on which an impairment-specific accessibility-compliant version of the initial design data is to be generated.

At 602, based on the user input, the end-user device 102 may transmit to the computing platform 101 a data communication indicating a request on behalf of the content designer to generate impairment-specific accessibility-compliant design data that is usable to produce accessibility-compliant content for a given impairment, the request comprising (i) the initial design data and (ii) an indication of the given impairment.

The computing platform 101 may receive the data communication from the end-user device. At 603, the computing platform 101 may determine a set of operations that are to be applied to the initial design data in order to generate the impairment-specific accessibility-compliant design data that is usable to produce accessibility-compliant content for the given impairment. In this respect, determining the set of operations may comprise identifying a given impairment-specific accessibility-aware design service that is configured to apply a set of logical instructions to modify one or more values (e.g., design tokens) of the initial design data and thereby generate the impairment-specific accessibility-compliant design data that is usable to produce accessibility-compliant content for the given impairment. In line with the discussion above, the computing platform 101 may identify the given impairment-specific accessibility-aware design service based on the given impairment indicated in the request. For instance, the computing platform 101 may identify a particular subsystem of the computing system 120 that hosts a given impairment-specific accessibility-aware design service corresponding to the given impairment.

At 604, the computing platform 101 may apply each operation in the set of operations to the initial design data and thereby generate the impairment-specific accessibility-compliant design data that is usable to produce accessibility-compliant content for the given impairment. In line with the discussion above, generating the impairment-specific accessibility-compliant design data may involve providing the initial design data as input to the given impairment-specific accessibility-aware design service identified at 603, whereupon the computing system 120 may evaluate the initial design data and modify one or more design tokens based on impairment-specific design values for the given impairment.

After generating the impairment-specific accessibility-compliant design data, at 605, the computing platform 101 may cause the end-user device to display content in accordance with the impairment-specific accessibility-compliant design data for the given impairment. In line with the discussion above, this functionality may also involve displaying a visual representation of the impairment-specific accessibility-compliant design data for review and/or modification by the content designer, and the displayed content may be dynamically updated to reflect any modifications made by the content designer.

At 606, the computing platform 101 may provide the impairment-specific accessibility-compliant design data to the content producer computing platform 104, which may cause the content consumer end-user device 106 to display content in accordance with the impairment-specific accessibility-compliant design data. In line with the discussion above, the computing platform 101 may provide the impairment-specific accessibility-compliant design data to the content producer computing platform 104 in the form of a template file, such as a CSS or a JSON file, among other possibilities.

Turning now to FIG. 7, a simplified block diagram is provided to illustrate some structural components that may be included in an example back-end computing platform 700 that may be configured to carry out any of the various back-end platform functions disclosed herein, including any of the functions that may be carried out by the back-end computing platform 101, the computing system 110, and/or the computing system 120 as described above. At a high level, the example back-end computing platform 700 may generally comprise any one or more computing systems that collectively include one or more processors 702, data storage 704, and one or more communication interfaces 706, all of which may be communicatively linked by a communication link 708 that may take the form of a system bus, a communication network such as a public, private, or hybrid cloud, or some other connection mechanism. Each of these components may take various forms.

The one or more processors 702 may each comprise one or more processing components, such as general-purpose processors (e.g., a single- or a multi-core central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed. It should also be understood that the one or more processors 702 could comprise processing components that are distributed across a plurality of physical computing systems connected via a network.

In turn, the data storage 704 may comprise one or more non-transitory computer-readable storage mediums that are collectively configured to store (i) program instructions that are executable by one or more processors 702 such that the back-end computing platform 700 is configured to perform any of the various functions disclosed herein, including but not limited to any of the back-end-platform functions disclosed herein, and (ii) data that may be received, derived, or otherwise stored, for example, in one or more databases, file systems, repositories, or the like, by the back-end computing platform 700, in connection with performing any of the various back-end platform functions disclosed herein. In this respect, the one or more non-transitory computer-readable storage mediums of the data storage 704 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. It should also be understood that the data storage 704 may comprise computer-readable storage mediums that are distributed across a plurality of physical computing systems connected via a network.

The one or more communication interfaces 706 may be configured to facilitate wireless and/or wired communication with other systems and/or devices. Additionally, in an implementation where the back-end computing platform 700 comprises a plurality of physical computing systems connected via a network, the one or more communication interfaces 706 may be configured to facilitate wireless and/or wired communication between these physical computing systems (e.g., between computing and storage clusters in a cloud network). As such, the one or more communication interfaces 706 may each take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

Although not shown, the back-end computing platform 700 may additionally include or have an interface for connecting to one or more user-interface components that facilitate user interaction with the back-end computing platform 700, such as a keyboard, a mouse, a trackpad, a display screen, a touch-sensitive interface, a stylus, a virtual-reality headset, and/or one or more speaker components, among other possibilities.

It should be understood that the back-end computing platform 700 is one example of a computing platform that may be used with the embodiments described herein. Numerous other arrangements are possible and contemplated herein. For instance, in other embodiments, the back-end computing platform 700 may include additional components not pictured and/or more or fewer of the pictured components.

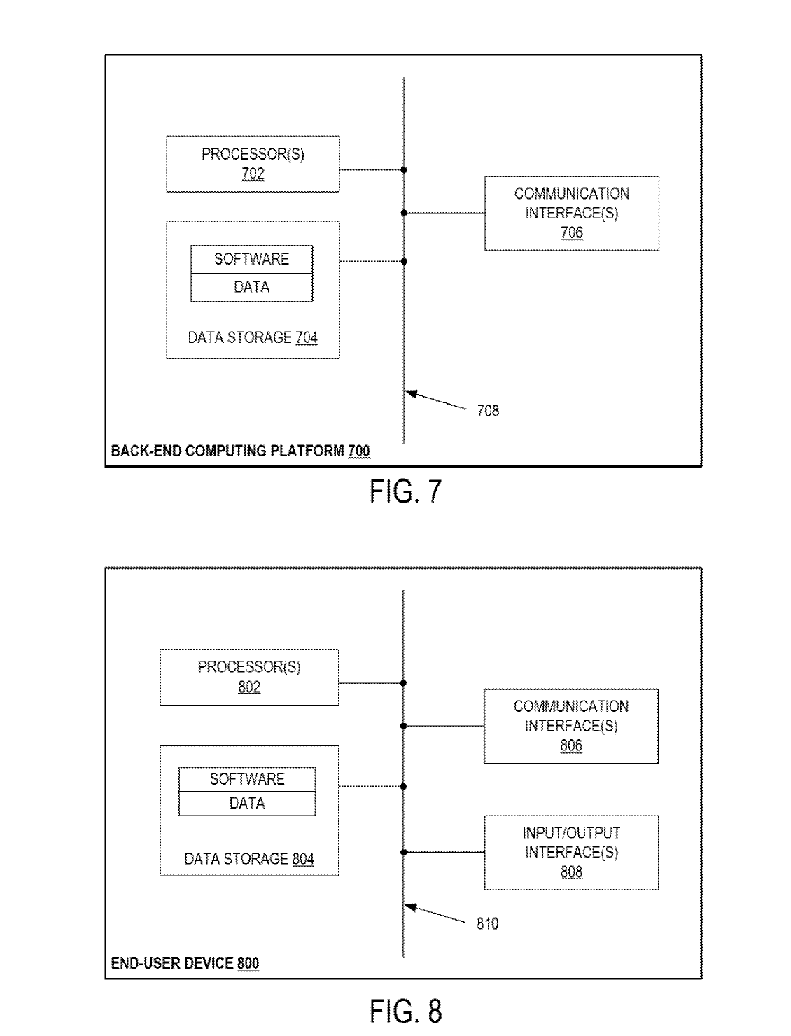

Turning next to FIG. 8, a simplified block diagram is provided to illustrate some structural components that may be included in an example end-user device 800 that may be configured to carry out any of the various functions disclosed herein, including but not limited to any of the various end-user device functionality discussed above, including any functionality carried out by a content designer end-user device 102 or a content consumer end-user device 106. As shown in FIG. 8, the end-user device 800 may include one or more processors 802, data storage 804, one or more communication interfaces 806, and one or more input/output (I/O) interfaces 808, all of which may be communicatively linked by a communication link 810 that may take the form of a system bus or some other connection mechanism. Each of these components may take various forms.

The one or more processors 802 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 804 may comprise one or more non-transitory computer-readable storage mediums that are collectively configured to store (i) program instructions that are executable by the processor(s) 802 such that the end-user device 800 is configured to perform any of the end-user device functions disclosed herein, and (ii) data that may be received, derived, or otherwise stored, for example, in one or more databases, file systems, repositories, or the like, by the end-user device 800. In this respect, the one or more non-transitory computer-readable storage mediums of the data storage 804 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. The data storage 804 may take other forms and/or store data in other manners as well.

The one or more communication interfaces 806 may be configured to facilitate wireless and/or wired communication with other computing devices. The communication interface(s) 806 may take any of various forms suitable to provide for any of various types of wireless communication (e.g., Wi-Fi communication, cellular communication, short-range wireless protocols, etc.) and/or wired communication. Other configurations are possible as well.

The end-user device 800 may additionally include or have interfaces for one or more I/O interfaces 808 that can be used to facilitate user interaction with the end-user device 800, such as a keyboard, a mouse, a trackpad, a display screen, a touch-sensitive interface, a stylus, a virtual-reality headset, and/or one or more speaker components, among other possibilities.

It should be understood that the end-user device 800 is one example of an end-user device that may be used to interact with an example computing platform as described herein. Numerous other arrangements are possible and contemplated herein. For instance, in other embodiments, the end-user device 800 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. Claims should not be construed as requiring action by such actors unless explicitly recited in claim language.

1. A computing platform comprising:
at least one processor;
at least one non-transitory computer-readable medium; and
program instructions stored on the at least one non-transitory computer-readable medium that are executable by the at least one processor such that the computing platform is configured to:
receive, from an end-user device associated with a user, one or more inputs collectively indicating (i) a request to generate impairment-specific accessibility-compliant design data, (ii) initial design data for displaying content and (iii) an indication of a given impairment;
based on the request, determine a set of operations to apply to the initial design data in order to generate the impairment-specific accessibility-compliant design data that is usable to produce accessibility-compliant content for the given impairment;
apply each operation in the set of operations to the initial design data and thereby generate the impairment-specific accessibility-compliant design data that is usable to produce accessibility-compliant content for the given impairment; and
cause the end-user device to display content in accordance with the impairment-specific accessibility-compliant design data for the given impairment.

2. The computing platform of claim 1, further comprising program instructions stored on the at least one non-transitory computer-readable medium that are executable by the at least one processor such that the computing platform is configured to:
cause the impairment-specific accessibility-compliant design data for the given impairment to be provided to a content producer computing platform for producing accessibility-compliant content for the given impairment.

3. The computing platform of claim 1, further comprising program instructions stored on the at least one non-transitory computer-readable medium that are executable by the at least one processor such that the computing platform is configured to:
cause the end-user device to display a visual representation of the impairment-specific accessibility-compliant design data for the given impairment.

4. The computing platform of claim 3, further comprising program instructions stored on the at least one non-transitory computer-readable medium that are executable by the at least one processor such that the computing platform is configured to:
receive, from the end-user device, an indication of user input comprising a modification to the impairment-specific accessibility-compliant design data;
based on the modification, update the impairment-specific accessibility-compliant design data; and
cause the end-user device to update the display of the content in accordance with the updated impairment-specific accessibility-compliant design data.

5. The computing platform of claim 1, wherein:
the program instructions that are executable by the at least one processor such that the computing platform is configured to determine the set of operations that is to be applied to the initial design data comprise program instructions that are executable by the at least one processor such that the computing platform is configured to:
identify a given impairment-specific accessibility-aware design service corresponding to the given impairment that is configured to dynamically modify one or more design values of the initial design data based on design values for the given impairment; and
the program instructions that are executable by the at least one processor such that the computing platform is configured to apply each operation in the set of operations to the initial design data and thereby generate the impairment-specific accessibility-compliant design data comprise program instructions that are executable by the at least one processor such that the computing platform is configured to:
provide the initial design data as input to the given impairment-specific accessibility-aware design service corresponding to the given impairment that is configured to dynamically modify one or more design values of the initial design data based on design values for the given impairment, wherein the generated impairment-specific accessibility-compliant design data comprises the dynamically modified one or more design values of the initial design data.

6. The computing platform of claim 5, wherein:
the given impairment comprises dyslexia;
the given impairment-specific accessibility-aware design service comprises a dyslexia-specific accessibility-aware design service; and
the set of operations comprises one or more of (i) modifying a font type design value to an OpenDyslexic font type, (ii) increasing a font weight design value, (iii) increasing a line height design value, (iv) increasing a contrast design value, or (v) changing a text alignment value to left-aligned text.

7. The computing platform of claim 5, wherein:
the given impairment comprises motion sensitivity;
the given impairment-specific accessibility-aware design service comprises a motion sensitivity-specific accessibility-aware design service; and
the set of operations comprises one or more of (i) deactivating auto-play of embedded videos, (ii) deactivating jiggling of design element outlines, (iii) deactivating looping animations, or (iv) reducing a size of an embedded design element.

8. The computing platform of claim 5, wherein:
the set of operations is a first set of operations;
the given impairment comprises a particular type of colorblindness;
the given impairment-specific accessibility-aware design service comprises a colorblindness-specific accessibility-aware design service; and
the first set of operations comprises (i) modifying a set of initial color values in the initial design data to an updated set of simulated color values that represent the set of initial color values as perceived by an individual with the particular type of colorblindness, thereby generating updated design data, (ii) based on a target accessibility compliance standard, determining a second set of operations to apply to the updated design data to generate colorblindness-specific accessibility-compliant design data for displaying content, and (iii) applying the second set of operations and thereby generating the colorblindness-specific accessibility-compliant design data.

9. The computing platform of claim 1, wherein the initial design data comprises accessibility-compliant design data previously generated by the computing platform.

10. A non-transitory computer-readable medium, wherein the non-transitory computer-readable medium is provisioned with program instructions that, when executed by at least one processor, cause a computing platform to:
receive, from an end-user device associated with a user, one or more inputs collectively indicating (i) a request to generate impairment-specific accessibility-compliant design data, (ii) initial design data for displaying content and (iii) an indication of a given impairment;
based on the request, determine a set of operations to apply to the initial design data in order to generate the impairment-specific accessibility-compliant design data that is usable to produce accessibility-compliant content for the given impairment;
apply each operation in the set of operations to the initial design data and thereby generate the impairment-specific accessibility-compliant design data that is usable to produce accessibility-compliant content for the given impairment; and
cause the end-user device to display content in accordance with the impairment-specific accessibility-compliant design data for the given impairment.

11. The non-transitory computer-readable medium of claim 10, wherein the non-transitory computer-readable medium is also provisioned with program instructions that, when executed by at least one processor, cause the computing platform to:
cause the impairment-specific accessibility-compliant design data for the given impairment to be provided to a content producer computing platform for producing accessibility-compliant content for the given impairment.

12. The non-transitory computer-readable medium of claim 10, wherein the non-transitory computer-readable medium is also provisioned with program instructions that, when executed by at least one processor, cause the computing platform to:
cause the end-user device to display a visual representation of the impairment-specific accessibility-compliant design data for the given impairment.

13. The non-transitory computer-readable medium of claim 12, wherein the non-transitory computer-readable medium is also provisioned with program instructions that, when executed by at least one processor, cause the computing platform to:
receive, from the end-user device, an indication of user input comprising a modification to the impairment-specific accessibility-compliant design data;
based on the modification, update the impairment-specific accessibility-compliant design data; and
cause the end-user device to update the display of the content in accordance with the updated impairment-specific accessibility-compliant design data.

14. The non-transitory computer-readable medium of claim 10, wherein:
the program instructions that, when executed by at least one processor, cause the computing platform to determine the set of operations that is to be applied to the initial design data comprise program instructions that, when executed by at least one processor, cause the computing platform to:
identify a given impairment-specific accessibility-aware design service corresponding to the given impairment that is configured to dynamically modify one or more design values of the initial design data based on design values for the given impairment; and
the program instructions that, when executed by at least one processor, cause the computing platform to apply each operation in the set of operations to the initial design data and thereby generate the impairment-specific accessibility-compliant design data comprise program instructions that, when executed by at least one processor, cause the computing platform to:
provide the initial design data as input to the given impairment-specific accessibility-aware design service corresponding to the given impairment that is configured to dynamically modify one or more design values of the initial design data based on design values for the given impairment, wherein the generated impairment-specific accessibility-compliant design data comprises the dynamically modified one or more design values of the initial design data.

15. The non-transitory computer-readable medium of claim 14, wherein:
the given impairment comprises dyslexia;
the given impairment-specific accessibility-aware design service comprises a dyslexia-specific accessibility-aware design service; and
the set of operations comprises one or more of (i) modifying a font type design value to an OpenDyslexic font type, (ii) increasing a font weight design value, (iii) increasing a line height design value, (iv) increasing a contrast design value, or (v) changing a text alignment value to left-aligned text.

16. The non-transitory computer-readable medium of claim 14, wherein:
the given impairment comprises motion sensitivity;
the given impairment-specific accessibility-aware design service comprises a motion sensitivity-specific accessibility-aware design service; and
the set of operations comprises one or more of (i) deactivating auto-play of embedded videos, (ii) deactivating jiggling of design element outlines, (iii) deactivating looping animations, or (iv) reducing a size of an embedded design element.

17. The non-transitory computer-readable medium of claim 14, wherein:
the set of operations is a first set of operations;
the given impairment comprises a particular type of colorblindness;
the given impairment-specific accessibility-aware design service comprises a colorblindness-specific accessibility-aware design service; and
the first set of operations comprises (i) modifying a set of initial color values in the initial design data to an updated set of simulated color values that represent the set of initial color values as perceived by an individual with the particular type of colorblindness, thereby generating updated design data, (ii) based on a target accessibility compliance standard, determining a second set of operations to apply to the updated design data to generate colorblindness-specific accessibility-compliant design data for displaying content, and (iii) applying the second set of operations and thereby generating the colorblindness-specific accessibility-compliant design data.

18. The non-transitory computer-readable medium of claim 10, wherein the initial design data comprises accessibility-compliant design data previously generated by the computing platform.

19. A method carried out by a computing platform, the method comprising:
receiving, from an end-user device associated with a user, one or more inputs collectively indicating (i) a request to generate impairment-specific accessibility-compliant design data, (ii) initial design data for displaying content and (iii) an indication of a given impairment;
based on the request, determining a set of operations to apply to the initial design data in order to generate the impairment-specific accessibility-compliant design data that is usable to produce accessibility-compliant content for the given impairment;
applying each operation in the set of operations to the initial design data and thereby generate the impairment-specific accessibility-compliant design data that is usable to produce accessibility-compliant content for the given impairment; and
causing the end-user device to display content in accordance with the impairment-specific accessibility-compliant design data for the given impairment.

20. The method of claim 19, further comprising:
causing the impairment-specific accessibility-compliant design data for the given impairment to be provided to a content producer computing platform for producing accessibility-compliant content for the given impairment.
